(19) United States
(12) Patent Application Publication
(10) Pub. No.: US 2007/0291985 A1
(43) Pub. Date: Dec. 20, 2007

(54) Intelligent railyard monitoring system

(76) Inventors: Nils Oliver Krahnstoever, Schenectady, NY (US); Rahul Bhotika, Albany, NY (US); David Michael Davenport, Niskayuna, NY (US); John Erik Hershey, Ballston Lake, NY (US); Robert James Mitchell, Waterford, NY (US); Emad Andarawis Andarawis, Ballston Lake, NY (US); Kenneth Brakeley Welles, Scotia, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/471,156

(22) Filed: Jun. 20, 2006

(51) Int. Cl. G06K 9/00

(52) U.S. Cl. 382/103

(57) ABSTRACT

Embodiments include an intelligent railyard monitoring system including a plurality of video devices, a device for interpreting captured images in operable communication with the plurality of video devices, a device controller in operable communication with the device for interpreting captured images wherein the system is capable of analyzing multiple video streams from the video devices to detect, locate, and track one or more targets and wherein the device for interpreting captured images includes a computing device.

### BACKGROUND

This disclosure relates generally to railyards, and more particularly to determining the location of persons and items, including railcars and locomotives, within a railyard.

Railyards are the hubs of railroad transportation systems. Therefore, railyards perform many services, for example, freight origination, interchange and termination, locomotive storage and maintenance, assembly and inspection of new trains, servicing of trains running through the facility, inspection and maintenance of railcars, and railcar storage. The various services in a railyard compete for resources such as personnel, equipment, and space in various facilities so that managing the entire railyard efficiently is a complex operation.

The railroads in general recognize that yard management tasks would benefit from the use of management tools based on optimization principles. Such tools use a current yard status and a list of tasks to be accomplished to determine an optimum order in which to accomplish these tasks. Additionally, monitoring of resources and activities is essential for efficient and safe railyard operation. However, human operator-based monitoring is difficult, labor-intensive, and error-prone. Furthermore, the persons in charge of the yard lack sufficient visibility into both individual yard processes and overall operations.

### BRIEF SUMMARY

Embodiments include an intelligent railyard monitoring system including a plurality of video devices, a device for interpreting captured images in operable communication with the plurality of video devices, a device controller in operable communication with the device for interpreting captured images, wherein the system is capable of analyzing multiple video streams from the video devices to detect, locate, and track one or more targets and wherein the device for interpreting captured images includes a computing device.

Other embodiments include an intelligent method for monitoring a railyard including receiving a plurality of video feeds from a plurality of video devices disposed within the railyard, detecting a target in the railyard, comparing the target to a database of known target types, classifying the target; and tracking the target through the railyard.

Further embodiments include a computer program for implementing an intelligent method for monitoring a railyard, the computer program product including instructions for implementing a method, including: receiving a plurality of video feeds from a plurality of video devices disposed within the railyard; detecting a target in the railyard; comparing the target to a database of known target types; classifying the target; and tracking the target through the railyard.

The above described and other features are exemplified by the following figures and detailed description.

### BRIEF DESCRIPTION OF DRAWINGS

These and other features, aspects, and advantages of the present disclosure will become better understood when the following detailed description is read with reference to the accompanying figures, wherein:

FIG. 1 illustrates an intelligent railyard monitoring system in accordance with exemplary embodiments;

FIG. 2 illustrates a block diagram of a device for interpreting captured images in accordance with exemplary embodiments;

FIG. 3 illustrates a flow chart of a method for detecting the presence of an unauthorized person in a railyard;

FIG. 4 illustrates a block diagram of a video device in accordance with exemplary embodiments; and

FIGS. 5a and 5b illustrate visualizations of the railyard in accordance with exemplary embodiments.

### DETAILED DESCRIPTION

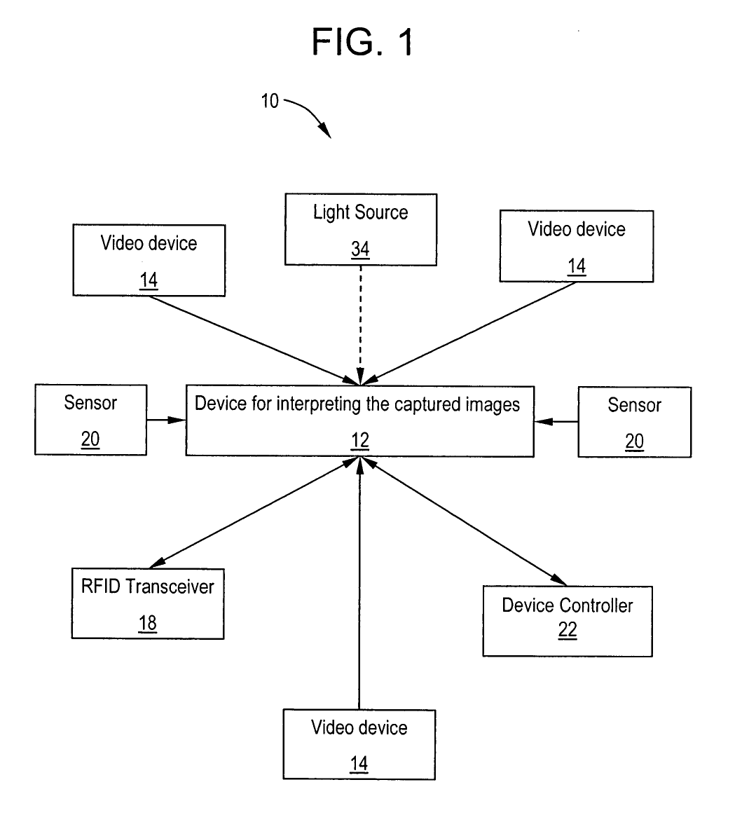

FIG. 1 illustrates an exemplary embodiment of an intelligent railyard monitoring system 10 that includes one or more devices for capturing images and a device for interpreting the captured images 12. Specifically, the system 10 includes one or more video devices 14, which may be configured to provide stereo views of at least a portion of the railyard. In one embodiment, stereo views can be obtained through the contemporaneous use of two or more video devices 14. In another embodiment, stereo views can be obtained through positioning of reflective devices, such as mirrors, near a video device 14 so as to provide more than one view. The video devices, or cameras 14 may be calibrated with respect to each other and/or with respect to a global railyard coordinate system. In an exemplary embodiment, the plurality of video devices 14 are disposed in and around the railyard to ensure comprehensive coverage of the entire railyard. The video devices may be mounted in a fixed or moveable manner. For example, a portion of the plurality of the video devices 14 may be mounted on an actuating device that controls the direction that the video device 14 is pointed and another portion of the plurality of the video device may be mounted such that the direction the video device 14 points in is fixed.

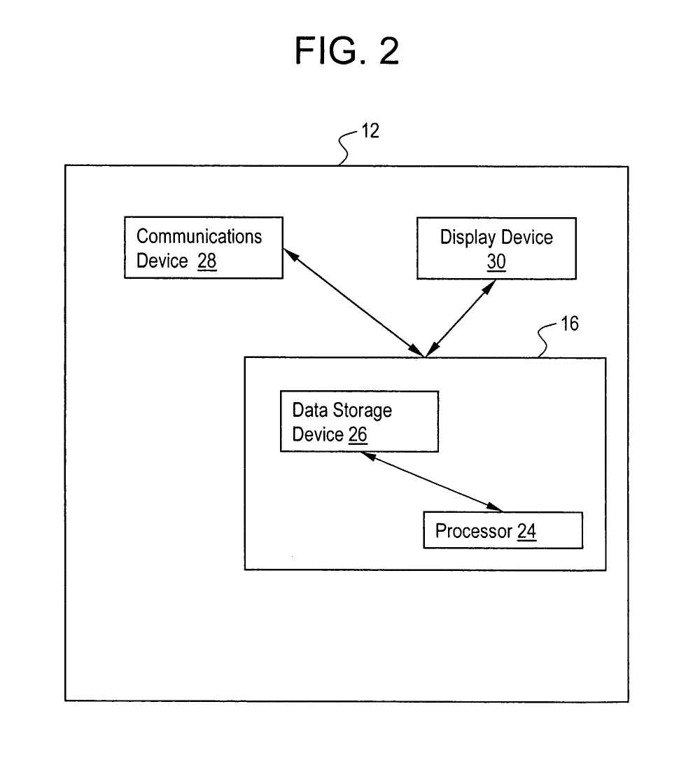

Referring now to FIG. 2, a block diagram of the device for interpreting the captured images 12 is illustrated. In one embodiment, the device for interpreting the captured images 12 includes a computing device 16 in operable communication with the plurality of video devices 14. The computing device 16 may be a personal computer or any other device suitable for performing calculations. The computing device 16 may include a processor 24 that is in operable communication with a data storage device 26. The device for interpreting the captured images 12 further includes a communications device 28, and a display device 30. The data storage device 26 may include, but is not limited to, a hard drive, a RAM, an optical data storage device, a FLASH memory, or the like. The communications device 28 may include, but is not limited to, a Network Interface Controller, a Modem, a USB connection, an RS 232 connection, a Serial connection, a RF transceiver, or the like. Likewise, the display device 30 may include, but is not limited to, a liquid crystal display, a CRT display, an electroluminescent display, a plasma display, or the like.

In exemplary embodiments, the computing device 16 may contain several programs for processing the received video feeds including, but not limited to, a facial recognition program, digital video and image signal processing software, and the like.

Currently, the cost of wiring is a major factor in the overall cost of most surveillance networks, particularly in surveillance networks designed to cover a large physical area such as a railyard. Accordingly, in one embodiment the device for interpreting the captured images 12 may include a wireless communications device 32 and the video devices 14 may include wireless communications modules that combine to enable wireless communication between the devices for interpreting the captured images 12 and the video devices 14. In one embodiment, a portion of the plurality of the video devices 14 are connected to the device for interpreting the captured images 12 through a wired connection, and another portion of the plurality of the video devices are wireless and are connected to the device for interpreting the captured images 12. The wireless communications device and the wireless communications module may utilize a wide variety of wireless communications protocols including, but not limited to, 802.11b/g/a, Infrared, Bluetooth™, or the like.

Returning to FIG. 1, the intelligent railyard monitoring system 10 may include a radio frequency identification (RFID) reader 18 in operable communication with the device for interpreting the captured images 12. The reader 18 is configured to enable the computing device 16 to obtain information regarding the position of any item upon which an RFID tag is located. RFID refers to the general category of radio frequency enabled identification tags. Within the railroad environment, RFID is termed Automatic Equipment Identification (AEI). Nearly all railcars operating within North America are equipped with AEI tags. For example, each container in the railyard may be equipped with an RFID tag that allows the computing device 16 to track the presence and approximate location of each container in the railyard. In addition to position information the RFID tag can be used to provide the computing device 16 with additional information about the item upon with the RFID tag is located. For example, the information contained on the RFID tag may indicate the origin, destination, owner, contents, or other information regarding the container. The intelligent railyard monitoring system 10 may contain either passive or active tags RFID tags or a combination of the two.

Furthermore, the intelligent railyard monitoring system 10 includes one or more sensors 20 that are disposed in or around the railyard. The sensors 20 are in operable communication with the device for interpreting the captured images 12. The sensors 20 may be designed to monitor a wide variety of conditions within the railyard. For example, the sensors 20 may be configured to provide information including, but not limited to, movement, temperature, auditory, and the like. In an exemplary embodiment, the device for interpreting the captured images 12 may communicate with the sensors 20 using either wired or wireless communications protocols or a combination of the two. In one embodiment, the computing device 16 is provided with the location of each sensor 20 in relation to the video devices 14 or with respect to the global railyard coordinate system.

In one embodiment, the intelligent railyard monitoring system 10 may also include a device controller 22, which is in operable communication with the computing device 16. The device controller 22 may be used to control any peripheral device in the railyard responsive to commands received from the device for interpreting the captured images 12. The device controller 22 may be a wide range of devices including, but not limited to, an alarm system, an actuator connected to a gate or a door, a lighting control system, a railway switch, an actuator connected to a video device 14, and actuator connected to a sensor 20, or the like. In one embodiment, the device for interpreting the captured images 12 may monitor the video devices 14 and/or the sensors 20 and upon the detection of an event, the device for interpreting the captured images 12 may instruct the device controller 22 to take a responsive action.

For example, the device for interpreting the captured images 12 may detect the presence of a person in a restricted area of the railyard and may responsively instruct the device controller 22 to sound an alarm. In another example, the device for interpreting the captured images 12 may detect an impending collision between two railcars and responsively instruct the device controller 22 to activate a railway switch to avoid the collision. In yet another example, the computing device may detect movement in an area of the railyard and instruct an actuator affixed to a video device 14 to point in the direction of the detected movement.

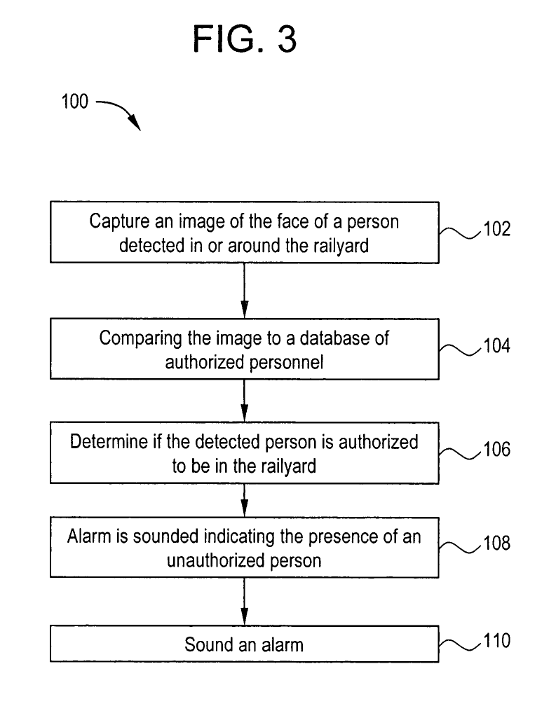

Referring now to FIG. 3, a flow chart of a method for detecting the presence of an unauthorized person in a railyard is depicted generally as 100. The first step in the method 100 is to capture an image of a person and/or the person's face detected in or around the railyard, as shown at method step 102. After capturing the image of the person detected, the method 100 includes comparing the image to a database of authorized personnel, as shown at method step 104. The method 100, at method step 106, determines if the detected person is authorized to be in the railyard. If the person is not authorized to be in the railyard the method 100 proceeds to method step 108 where an alarm is sounded indicating the presence of an unauthorized person. Otherwise the method terminates at method step 106. For example, portions of the railyard may be restricted to certain individuals, other portions of the railyard may be unrestricted, and further portions of the railyard may not be normally accessed by anyone. Accordingly, the intelligent railyard monitoring system can be utilized to monitor the different portions of the railyard for the presence of individuals and determine if their presence is authorized.

Continuing with reference now to FIG. 2, the device for interpreting the captured images 12 is capable of analyzing single or multiple video streams simultaneously to detect, localize, and track a single or multiple targets. In exemplary embodiments, targets may include, but are not limited to, yard resources, persons in the yard, railcars, locomotive engines, and the like. In one embodiment, the detection of a target is based on foreground-background segmentation of captured video followed by a template-based target classification. For example, the computing device 16 separates background image regions that remain approximately constant for an extended period of time from foreground image regions, which change more frequently due to target motion. After detecting a target, the computing device 16 attempts to classify the target by comparing the target to templates of known target types. In another embodiment, targets are detected and classified based on tracking features such as corners in the image, followed by spatially clustering these tracked features into groups of features corresponding to targets. In yet another embodiment, targets are detected and classified based on tracking features such as flashing strobe lights. Such lights are typically installed on locomotives operating within a railyard as a safety device to alert others of the locomotive's presence and movement. Strobe lights could be placed on a variety of yard assets including vehicles. Strobes could flash at different rates or using different colors to assist in the detection and classification of targets within the railyard.

Once a target is detected and classified, the location of each target is tracked by the computing device 16. The location may be tracked with respect to either the global railyard coordinate system, from frame-to-frame between video devices, or both. In one embodiment, the target tracking system utilizes one or more detailed models of the railyard and the tracked targets to constrain the possible movements of targets and hence improve tracking performance. The intelligent railyard monitoring system 10 may keep a log of the current and/or past locations of each target for a predetermined period of time using the computing device 16. In one embodiment, the data storage device of the computing device 16 may be periodically backed-up onto a removable data storage device such as a CD, DVD, or tape drive.

In one embodiment, the intelligent railyard monitoring system 10 may be configured to monitor specific tasks or actions. These tasks may be specified interactively by an operator or be pre-specified in the system. Exemplary tasks or actions may include, but are not limited to, monitoring the receiving yard to report the train arrival, monitoring the departure yard to report the time at which the crew boards the train, monitoring the movement of any individuals in particular areas of the railyard, or monitoring the movements of all individuals in the railyard. In another example, the intelligent railyard monitoring system 10 may monitor railcars differently depending upon the type of cargo the railcar is carrying. For example, if the RFID tag or other identification system indicated that a particular railcar is carrying a hazardous material, the railyard monitoring system 10 may maintain constant video surveillance of the railcar and may sound an alarm if a person is detected within a specific range of the railcar.

The computing device 16 may include a software package that is designed to analyze behavioral patterns of identified persons to verify that the individuals are acting within normal behavioral patterns. For example, the computing device 16 may track individuals once they have been identified and compare their behavioral pattern with behavioral patterns associated with the job function of the identified individual. Additionally, the computing device 16 can also determine whether or not individuals are being coerced or are under the influence of alcohol or in other ways debilitated. For example, the computing device 16 may compare behavior and/or movement (e.g., gait of the individual) with the previously observed behavior and/or movement of the same individual. In the event that the computing device 16 identifies that the behavioral pattern of an individual is outside of the expected behavioral pattern, the computing device 16 may alert a user or sound an alarm.

In exemplary embodiments, the intelligent railyard monitoring system may be used to detect hazardous working conditions in the railyard and sound an alarm upon the detection. For example, the intelligent railyard monitoring system may detect a railcar approaching a worker in a blue flag zone and sound an audible alarm to warn the worker, activate the breaks of the railcar, or switch the track of the railcar to avoid the collision. In another example, the intelligent railyard monitoring system may detect a potential collision between two railcars in the railyard. In one embodiment, the intelligent railyard monitoring system can control various railyard resources in response to the detection of a hazardous working condition. For example, the intelligent railyard monitoring system may instruct a railcar to stop upon detection that it is approaching a worker or another railcar.

In other exemplary embodiments, the intelligent railyard monitoring system may detect the beginning and end of work processes (i.e., when a worker begins or finishes a scheduled task). For example, the intelligent railyard monitoring system may be used to track personnel in the railyard and keep a log of their activities in the railyard including when they began and concluded specific work tasks. In addition to tracking workers, the log information can also be used in time studies for process engineers. In one embodiment, if a worker is taking an abnormally long period of time to complete a task an alert or alarm may be issued to notify a controller of the abnormality.

Hump yards are the largest and most effective classification railyards with the largest shunting capacity. The heart of these yards is the hump: a lead track on a hill, or hump, over which the engine pushes the cars. Single cars, or some coupled cars in a block, are uncoupled just before or at the crest of the hump and roll by gravity into their destination tracks. The intelligent railyard monitoring system may be used for monitoring the velocity of railcars pushed over the yard hump and feeding the velocity information into the hump control system that determines how much break force to apply to slow the cart down to just the right coupling velocity. Additionally, the intelligent railyard monitoring system can be used for detecting if railcars, being pushed over the hump, are switched correctly onto the right tracks and report errors if they are switched incorrectly.

Furthermore, the intelligent railyard monitoring system can be used for detecting train arrival and departure of railcars. In exemplary embodiments, the intelligent railyard monitoring system may include a schedule of all incoming and departing railcars and may monitor the railyard for arrivals and departures. The intelligent railyard monitoring system may use the information to keep a log of actual versus scheduled arrival and departure times. Additionally, if the intelligent railyard monitoring system detects an unscheduled arrival or departure it may sound an alarm or alert.

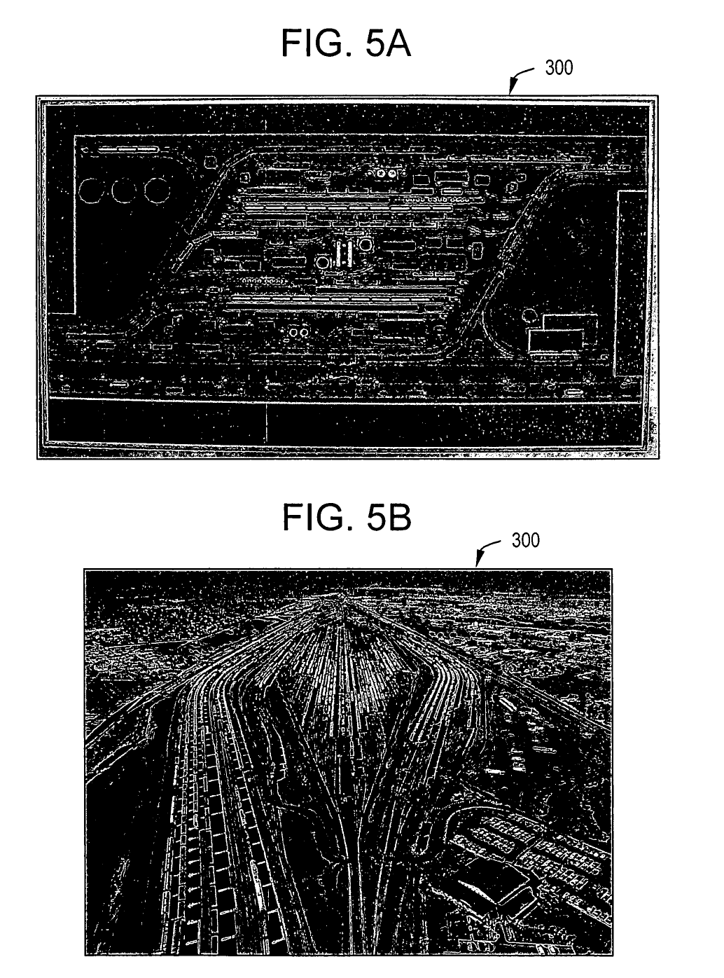

In exemplary embodiments, the intelligent railyard monitoring system may include a visualization of the railyard, as depicted generally in FIGS. 5a and 5b as 300. The visualization 300 may be comprised of multiple camera views that are combined to form a single image (e.g., a mosaic), which may be displayed as a top-down picture of the yard. In addition, all detected and track yard activity can be presented to yard operators in this mosaic view giving a comprehensive and intuitive awareness over the entire yard. In one embodiment, the user of the intelligent railyard monitoring system may be able to rotate the viewing angle, zoom in and out, and change the elevation of the visualization 300. For example, the intelligent railyard monitoring system may construct a three-dimensional model of the railyard and allow the user to change the perspective that of the visualization 300 of the railyard.

In one embodiment, the intelligent railyard monitoring system 10 may include one or more auxiliary light source 34 for improved performance during periods of low illumination (e.g., night, inclement weather). The auxiliary light source 34 may include a spotlight, an infrared light, or the like. The light source 34 may be in operable communication with the device controller 22 and/or the computing device 16, which may control the operational mode of the light source 34 (e.g., if the light source is on or off and the intensity of the light emitted by the light source). The light source 34 may be disposed anywhere in or around the railyard including, but not limited to, on a railcar, on a building, on a pole, or the like. Depending on the location of the light source 34, the light source 34 may communicate with the device controller 22 and/or the computing device 16 through either wired or wireless means. In one embodiment, infrared light sources may be installed on all yard engines to facilitate system performance during all lighting conditions. The light sources 24 may be mounted in either a fixed or a moveable manner. In one embodiment, the light source is mounted on an actuator that is in operable communication with the device controller 22, which controls the direction the light source is pointed.

The video device 14 may include a solar array that can be used to charge a battery that provides power to the video device 14. In one embodiment, the video device 14 may contain a video analysis algorithm operable for determining the required frequency of video capture and whether or not a captured image must be transmitted and at what compression rate. For example, the video device 14 may have a video analysis algorithm that is capable of comparing a captured image with a previously captured image that can be used to prevent the video device from transmitting a substantially duplicate image. In an exemplary embodiment, the video devices 14 are programmed to only transmit an image once a change in the environment that they are observing is detected. Additionally, the video devices 14 may be designed to send an updated image on a regular schedule to ensure that the video devices are still functioning properly. The computing device 16 collects the transmitted imagery and updates the representation of the railyard maintained by the computing device 16.

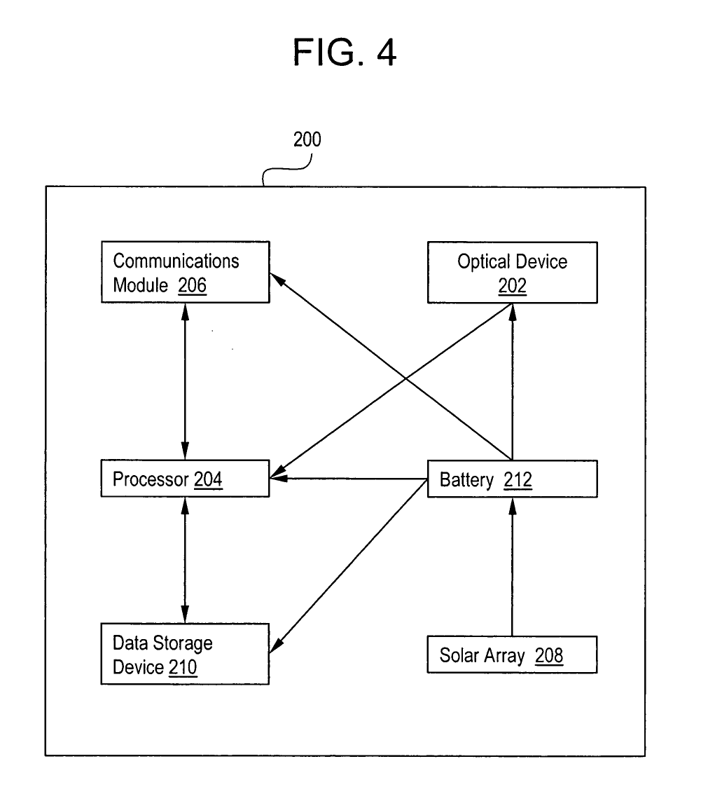

Referring now to FIG. 4, a block diagram of an exemplary embodiment of a video device is generally depicted as 200. The video device includes an optical device 202, a processor 204, a communications module 206, a solar array 208, a data storage device 210, and a battery 212. The optical device 202 is operable for capturing images and is in operable communication with the processor 204. The data storage device 210 is operable for storing captured images and is in operable communication with the processor 204. The communications module 206 may be capable of wireless or wired communications and is in operable communication with the processor 204. In an exemplary embodiment, the battery 210 is a rechargeable battery in operable communication with the solar array 208, which is operable for charging the battery 210. The data storage device 210 may be selected from a wide variety of devices including, but not limited to, a hard drive, a RAM, an optical data storage device, a FLASH memory, or the like. Likewise, the communications module 206 may be selected from a wide variety of devices including, but not limited to, an Ethernet Network Interface, a modem, an 802.b/g/a wireless controller, Radio-Frequency device, Infrared device, Bluetooth™ device, or the like.

As described above, the present disclosure can be embodied in the form of computer-implemented processes and apparatuses for practicing those processes. The present disclosure can also be embodied in the form of a computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the disclosure. The present disclosure can also be embodied in the form of a computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the disclosure. When implemented on a general-purpose microprocessor, the computer program code segments configure the microprocessor to create specific logic circuits.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. An intelligent railyard monitoring system comprising:
a plurality of video devices disposed within a railyard;
a device for interpreting captured images in operable communication with the plurality of video devices; and
a device controller in operable communication with the device for interpreting captured images, wherein the system is capable of analyzing multiple video streams from the video devices to detect, locate, and track one or more targets, and wherein the device for interpreting captured images includes a computing device.

2. The intelligent railyard monitoring system of claim 1, wherein the device for interpreting captured images comprises:
a data storage device;
a communications device; and
a display device.

3. The intelligent railyard monitoring system of claim 2, wherein the communications device is a wireless communications device.

4. The intelligent railyard monitoring system of claim 1, wherein the device controller is in operable communication with at least a portion of the plurality of video devices and is operable for controlling the direction that the portion of the plurality of video devices is pointed.

5. An intelligent method for monitoring a railyard comprising:
receiving a plurality of video feeds from a plurality of video devices disposed within the railyard;
detecting a target in the railyard;
classifying the target; and
tracking the target through the railyard.

6. The intelligent method for monitoring a railyard of claim 5, wherein classifying the target in the railyard comprises comparing the target to a database of known target types.

7. The intelligent method for monitoring a railyard of claim 5, wherein detecting the target in the railyard comprises a foreground-background segmentation of at least a portion of the video feeds.

8. The intelligent method for monitoring a railyard of claim 5, wherein an optical illumination device is disposed on a yard asset to be tracked.

9. The intelligent method for monitoring a railyard of claim 8, wherein the optical illumination device is configured to flash at a specific rate or using a specific wavelength to facilitate classification of one type of asset from another.

10. The intelligent method for monitoring a railyard of claim 5, wherein classifying the target comprises a template-based target classification system.

11. The intelligent method for monitoring a railyard of claim 5, wherein tracking the target through the railyard includes the use of a global railyard coordinate system.

12. The intelligent method for monitoring a railyard of claim 5, wherein tracking the target through the railyard comprises tracking the target from frame to frame and from video device to video device.

13. The intelligent method for monitoring a railyard of claim 5, wherein the tracking of the target is preformed responsive to the classification of the target.

14. The intelligent method for monitoring a railyard of claim 5, further comprising activating an alert responsive to the classification of the target.

15. The intelligent method for monitoring a railyard of claim 5, further comprising activating an alert responsive to the tracking of the target.

16. A computer program for implementing an intelligent method for monitoring a railyard, the computer program product comprising:
a storage medium readable by a processing circuit and storing instructions for execution by the processing circuit for facilitating a method comprising:
receiving a plurality of video feeds from a plurality of video devices disposed within the railyard;
detecting a target in the railyard;
comparing the target to a database of known target types;
classifying the target; and
tracking the target through the railyard.

17. The computer program product of claim 16, wherein detecting the target in the railyard comprises a foreground-background segmentation of at least a portion of the video feeds.

18. The computer program product of claim 16, wherein classifying the target comprises a template-based target classification system.

19. The computer program product of claim 16, wherein tracking the target through the railyard includes the use of a global railyard coordinate system.

20. The computer program product of claim 16, wherein the tracking of the target is performed responsive to the classification of the target.
